(19) United States
(12) Patent Application Publication
(10) Pub. No.: US 2025/0104619 A1
(43) Pub. Date: Mar. 27, 2025

(54) EYE-ADAPTIVE DISPLAY

(71) Applicant: Varjo Technologies Oy, Helsinki (FI)

(72) Inventor: Mikko Strandborg, Helsinki (FI)

(73) Assignee: Varjo Technologies Oy, Helsinki (FI)

(21) Appl. No.: 18/471,379

(22) Filed: Sep. 21, 2023

(51) Int. Cl. G09G 3/3208

(52) U.S. Cl. CPC G09G 3/3208; G09G 2320/0626; G09G 2354/00

(57) ABSTRACT

Disclosed is a display apparatus comprising eye-tracking means, display(s) per eye, and processor(s). The processor(s) is/are configured to: process eye-tracking data, collected by the eye-tracking means, to detect a current pupil size; determine a given luminosity range corresponding to the current pupil size; employ at least one of: a tone-mapping technique, an exposure-adjustment technique, to map luminosity values of pixels in a high dynamic range (HDR) image to luminosity values of corresponding pixels in an output image, wherein the luminosity values of the pixels in the output image lie in the given luminosity range; and display the output image via the display(s).

### TECHNICAL FIELD

The present disclosure relates to eye-adaptive display apparatuses. The present disclosure also relates to methods implemented by such eye-adaptive display apparatuses.

### BACKGROUND

High Dynamic Range (HDR) display devices have gained widespread popularity in consumer market. These display devices aim to enhance viewing experiences of users by expanding a range of luminosities they can provide to the users. A human eye can discern luminosity differences, for example, at an approximate ratio of 1:1000. This means that a contrast sensitivity for the human eye is quite high. If this were the sole consideration, a 10-bit colour depth would suffice to represent an entire range of human vision, which amounts to 1024 distinguishable luminosity levels.

However, the human eye possesses various adaptation mechanisms that can extend a luminosity range. These mechanisms enable the human eye to function effectively in environments with varying light levels (for example, from very dark to very bright levels of light) spanning nine orders of magnitude. For example, a brightest light signal that the human eye can perceive is approximately one billion times stronger than a dimmest light signal it can perceive. Among such adaptation mechanisms, a pupil adaptation mechanism offers approximately a ten times extension of the luminosity range but may take a significant amount of time to activate (for example, 20 minutes to 60 minutes). Notably, these adaptations result in a perception of luminosity changes on a logarithmic scale.

Due to such adaptation mechanisms and physiology of human vision cells, change in luminosity is perceived on a logarithmic scale. For this reason, a traditional display employ an exponential curve (often referred to as a gamma curve) to map luminosities on a display to discrete steps of a particular colour range (for example, such as an 8-bit or a 10-bit colour range). This means that the display allocates a greater number of colour steps to accurately reproduce subtle differences in darker areas of an image, as the human eye is more sensitive to changes in low-light conditions. Conversely, fewer colour steps are allocated to represent variations in brighter areas of the image, as the human eye is less sensitive to small differences in brightness.

Furthermore, HDR displays typically employ higher colour depths and increased maximum luminosity levels to achieve a more extensive dynamic visual range. Particularly, especially in a domain of computer graphics, tone mapping technique is used to map one set of colours to another set of colours in order to approximate appearance of HDR images when viewed on a display having a limited dynamic range.

Therefore, in light of the foregoing discussion, there exists a need to overcome the aforementioned drawbacks.

### SUMMARY

The present disclosure seeks to provide an eye-adaptive display apparatus and a method implemented by such an eye-adaptive display apparatus, to generate highly realistic and accurate output images by mapping luminosity values of pixels in an HDR image according to a given luminosity range corresponding to a current pupil size. The aim of the present disclosure is achieved by an eye-adaptive display apparatus and a method implemented by such an eye-adaptive display apparatus, as defined in the appended independent claims to which reference is made to. Advantageous features are set out in the appended dependent claims. Throughout the description and claims of this specification, the words “comprise”, “include”, “have”, and “contain” and variations of these words, for example “comprising” and “comprises”, mean “including but not limited to”, and do not exclude other components, items, integers, or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates a block diagram of an architecture of an eye-adaptive display apparatus, in accordance with an embodiment of the present disclosure;

FIG. 2 illustrates an exemplary sequence diagram of a data flow in an eye-adaptive display apparatus, in accordance with an embodiment of the present disclosure;

FIG. 3 illustrates an exemplary tone mapping curve representing a non-linear mapping of luminosity values of pixels in a high dynamic range (HDR) image to luminosity values of corresponding pixels in an output image, in accordance with an embodiment of the present disclosure; and

FIG. 4 illustrates steps of a method implemented by an eye-adaptive display apparatus, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides a display apparatus comprising:
eye-tracking means;
at least one display per eye; and
at least one processor configured to:
   process eye-tracking data, collected by the eye-tracking means, to detect a current pupil size of a user's eye;
   determine a given luminosity range corresponding to the current pupil size;
   employ at least one of: a tone-mapping technique, an exposure-adjustment technique, to map luminosity values of pixels in a high dynamic range (HDR) image to luminosity values of corresponding pixels in an output image, wherein the luminosity values of the pixels in the output image lie in the given luminosity range; and
   display the output image via the at least one display.

In a second aspect, an embodiment of the present disclosure provides a method comprising:
processing eye-tracking data, collected by eye-tracking means, to detect a current pupil size of a user's eye;
determining a given luminosity range corresponding to the current pupil size;
employing at least one of: a tone-mapping technique, an exposure-adjustment technique to map luminosity values of pixels in a high dynamic range (HDR) image to luminosity values of corresponding pixels in an output image, wherein the luminosity values of the pixels in the output image lie in the given luminosity range; and
displaying the output image via at least one display.

The present disclosure provides the aforementioned display apparatus and the aforementioned method implemented by such a display apparatus, for generating high-quality and realistic output images, in a computationally-efficient and a time-efficient manner. Herein, the given luminosity range corresponding to the current pupil size is determined, and then the luminosity values of the pixels in the HDR image are mapped 10 to the luminosity values of the corresponding pixels in the output image that lie in the given luminosity range. In this way, the output image can be highly realistic and accurately displayed at the at least one display. Moreover, performing said mapping according to the given luminosity range facilitates in enhancing visual comfort and reducing a potential for visual discomfort/strain caused by overly bright or dim areas in the output image. This provides an adaptive viewing experience of the user when the output image is shown to the user. The display apparatus and the method are simple, robust, support real-time and reliable eye-adaptive displaying of output image(s), and can be implemented with ease.

Throughout the present disclosure, the term “display apparatus” refers to specialized equipment that is capable of displaying images. These images are to be presented to a user of the display apparatus. Optionally, the display apparatus is implemented as a head-mounted display (HMD) device. The term “head-mounted display” device refers to specialized equipment that is configured to present an extended-reality (XR) environment to the user when said HMD device, in operation, is worn by the user on his/her head. The HMD device is implemented, for example, as an XR headset, a pair of XR glasses, and the like, that is operable to display a visual scene of the XR environment to the user. The term “extended-reality” encompasses virtual reality (VR), augmented reality (AR), mixed reality (MR), and the like.

Notably, the at least one processor controls an overall operation of the display apparatus. The at least one processor is communicably coupled to the eye-tracking means and to the at least one display.

Throughout the present disclosure, the term “eye-tracking means” refers to specialized equipment for detecting and/or following user's eyes, when the display apparatus (for example, the HMD device), in operation, is worn by the user. The eye-tracking means could be implemented as contact lenses with sensors, cameras monitoring a position, a size and/or a shape of a pupil of a given eye of the user, and the like. The eye-tracking means are well-known in the art.

It will be appreciated that when a visual scene of the XR environment is presented to the user, a pupil size of the user's eye may keep changing depending on a variation of brightness (namely, light intensity) across the visual scene. This is due to the fact that the pupil size of the user's eye is naturally adjusted (namely, increased or decreased) to control an amount of light incident on the user's eye. For example, the pupil size decreases (namely, the pupil constricts) when the user views a region in the visual scene having a relatively higher brightness. On the other hand, the pupil size increases (namely, the pupil dilates) when the user views a region in the visual scene having a relatively lower brightness. Therefore, the current pupil size of the user's eye would correspond to a given time instant when the user views/gazes at a particular region in the visual scene.

It will also be appreciated that the eye-tracking data is collected repeatedly by the eye-tracking means throughout a given session of using the display apparatus, as the pupil size of the user's eye may keep changing whilst he/she uses the display apparatus. The eye-tracking data may comprise images/videos of the user's eye, sensor values, and the like. Optionally, when processing the eye-tracking data to detect the current pupil size, the at least one processor is configured to employ at least one of: an image processing algorithm, a feature extraction algorithm, a data processing algorithm. The pupil size could, for example, be expressed in terms of a number of pixels, a percentage of constriction of the pupil with respect to its maximum size, a percentage of dilation of the pupil with respect to its minimum size, or similar. The pupil size may be referred to as a diameter of the pupil. A calibration process may also be employed here: either pre-calibration, continuous calibration, or on-line calibration, which maps the current pupil size to a luminosity range that the eye can comfortably view. Processing the eye-tracking data to detect the current pupil size is well-known in the art.

Optionally, the current pupil size is detected for both a first eye and a second eye of the user, and then an average current pupil size is calculated and utilised for determining the given luminosity range. Alternatively, optionally, the current pupil size is detected for both the first eye and the second eye, and the given luminosity range is determined for the first eye and the second eye individually. Yet alternatively, optionally, the current pupil size is detected for one of the first eye or the second eye, and is replicated for the another of the first eye or the second eye. In such a case, the given luminosity range may also be determined for the first eye and the second eye individually.

Throughout the present disclosure, the term “luminosity” refers to brightness or an intensity of light emitted by a given display. Greater the luminosity of the given display, greater is the brightness of the given display, and vice versa. Typically, the luminosity of the given display is expressed in terms of nits or candelas per square meter. For example, an a Liquid Crystal Display (LCD) monitor or a smartphone screen may have a luminosity range of 200 nits to 1000 nits. Luminosity is well-known in the art.

Notably, determining the given luminosity range means determining a lower bound (namely, a minimum luminosity value of a pixel in the output image) and an upper bound (namely, a maximum luminosity value of a pixel in the output image) of the given luminosity range, based on the current pupil size. In this regard, the given luminosity range would comprise a plurality of luminosity values that lie between the lower bound and the upper bound. In an example, the given luminosity range may be 0-255, wherein 0 is the lower bound and 255 is the upper bound. In another example, the given luminosity range may be 1-200, wherein 1 is the lower bound and 200 is the upper bound. It is to be understood that the lower bound of the given luminosity range need not necessarily be zero.

Throughout the present disclosure, the term “luminosity value” of a given pixel of an image refers to a brightness value of the given pixel. For an 8-bit image, a luminosity value of the given pixel may lie in a range of 0-255. Similarly, for a 10-bit image, a luminosity value of the given pixel may lie in a range of 0 to 1023. For a 16-bit image, a luminosity value of the given pixel may lie in a range of 0 to 65535. It is to be understood that the lower bound corresponds to a minimum brightness of the given pixel, and the upper bound corresponds to a maximum brightness of the given pixel. Luminosity values are well-known in the art. Alternatively, the image luminosity values may be represented in the range of 0-1 where 0 maps to the lowest possible luminosity and 1 to the highest. The brightness levels are quantized into 2⁸, 2¹⁰ or 2¹⁶ discrete levels for 8, 10 and 16-bit images, respectively.

Optionally, when determining the given luminosity range, the at least one processor is configured to employ a lookup table, wherein the lookup table comprises different luminosity ranges corresponding to different pupil sizes. Such a lookup table could be generated prior to a given session of using the display apparatus, by performing an initial calibration. In this regard, the user may be required to wear a wearable device that comprises the eye-tracking means, and to view at least one reference image displayed on a display of the wearable device, wherein the at least one reference image represents a visual scene having varying brightness. The pupil size of the user's eye is measured when the user views different regions of the at least one reference image and corresponding luminosity ranges that are comfortable/suitable for said viewing, are recorded for generating the lookup table. It will be appreciated that the aforesaid calibration could be performed for multiple users and an average of different luminosity ranges corresponding to different pupil sizes of the multiple users is used for generating the lookup table. Moreover, the aforesaid calibration could also be an on-the-fly calibration in which the corresponding luminosity ranges are updated based on real-time measurements of the pupil size. Optionally, the lookup table is stored at a data repository that is communicably coupled to the at least one processor. The data repository could be implemented, for example, such as a memory of the at least one processor, a memory of the display apparatus, a removable memory, a cloud-based database, or similar.

Alternatively, optionally, when determining the given luminosity range, the at least one processor is configured to employ at least one polynomial function for calculating the lower bound and/or the upper bound of the given luminosity range. In this regard, the pupil sizes and the corresponding luminosity ranges obtained during the aforesaid calibration could be utilised (by the at least one processor) for generating the at least one polynomial function. In an example, for the upper bound, the polynomial function may be a standard quadratic polynomial function f(x)=a*x2+b*x+c, wherein x is the pupil size, and a, b, and c are pre-determined coefficients. It will be appreciated that other mathematical functions for example, such as exponential functions or sigmoid functions could also be employed.

It is to be understood that the pixels of the HDR image generally have a wide range of luminosity values (namely, brightness levels), and when said HDR image would be displayed on the at least one display (for example, having a standard dynamic range) directly without any mapping, a full range of brightness levels the HDR image can actually represent would be lost or clipped. This often results in a loss of visual detail and an incorrect displaying of said HDR image on the at least one display. Pursuant to embodiments of the present disclosure, the luminosity values of the pixels in the HDR image are mapped to the luminosity values of the corresponding pixels in the output image that is to be subsequently displayed at the at least one display. Furthermore, since the HDR image generally represent a wide range of lighting conditions and brightness levels present in a visual scene, in order to make such a visual scene highly realistic and immersive when viewed on the at least one display, the aforesaid mapping is necessary. Additionally, when the luminosity values of the pixels in the HDR image are mapped according to the given luminosity range that is determined based on the current pupil size, the output image can be highly realistic and accurately displayed at the at least one display. Moreover, performing said mapping according to the given luminosity range facilitates in enhancing visual comfort and reducing a potential for visual discomfort/strain caused by overly bright or dim areas in the output image. This provides an eye-adaptive viewing experience of the user when the output image is shown to the user.

Notably, for performing the aforesaid mapping, the at least one of: the tone-mapping technique, the exposure-adjustment technique is employed by the at least one processor. The “tone-mapping technique” is an image processing technique used to convert HDR images into images that can be displayed on displays having a standard/low dynamic range. The “exposure adjustment technique” is an image processing technique used to control (namely, increase or decrease) an overall brightness of any image by adjusting exposure settings of said image or by adjusting luminosity values of pixels of said image. Upon performing exposure adjustment, said image would appear to have a balanced level of brightness and contrast. It will be appreciated that the tone-mapping technique and/or the exposure-adjustment technique may employ a mapping function that takes into account an original luminosity value of a give pixel in the HDR image and maps it to a new luminosity value of a corresponding pixel in the output image. Such a mapping function could, for example, be a Reinhard operator, a Mantiuk operator, or similar. The tone-mapping technique and/or the exposure-adjustment technique are well-known in the art. It will also be appreciated that in some cases, the tone-mapping technique may implement the exposure adjustment technique implicitly, while in others cases the tone-mapping technique and the exposure adjustment technique are performed separately (for example, the exposure adjustment technique is performed prior to employing the tone-mapping technique), along with employing other techniques such as colour grading, in a single pass.

It will be appreciated that prior to employing the at least one of: the tone-mapping technique, the exposure-adjustment technique, the at least one processor is configured to obtain the HDR image, for example, from the data repository (whereat the HDR image is pre-stored) or from an HDR content framebuffer. In an example, the HDR image may be a 16-bit image, having a maximum expressible contrast ratio of 1:65000000, and a maximum luminosity value of 65535 representing a maximum brightness of 1000 nits. Moreover, the output image may be an 8-bit image having a maximum brightness of 600 nits at a highest backlight level.

Optionally, a luminosity value of a given pixel in the HDR image that is higher than an upper bound of the given luminosity range is mapped to the upper bound. In this regard, the luminosity value of the given pixel in the HDR image that is higher than the upper bound corresponds to an extremely high brightness of the given pixel that may exceed the standard dynamic range of the at least one display, when the HDR image would be displayed at the at least one display directly without any mapping. Since the upper bound corresponds to the maximum brightness of a given pixel in the output image that the standard dynamic range of the at least one display could accommodate conveniently and accurately, said luminosity value of the given pixel is mapped to the upper bound. It will be appreciated that this may prevent pixels of the output image to appear to be completely white (namely, overexposed) when the output image is displayed at the at least one display. Such a mapping may ensure a balance between preserving important visual details and presenting a visually-pleasing content while avoiding excessive clipping that may lead to unnatural or undesirable artifacts in the output image.

Optionally, the at least one processor is configured to adjust an exposure setting of the tone-mapping technique based on the given luminosity range. In this regard, when the tone-mapping technique is employed, the exposure setting can be adjusted before applying the tone-mapping technique. The “exposure setting” of the tone-mapping technique is used to control an overall brightness or luminance of a lower dynamic range (LDR) image during a process of converting the HDR image to the LDR image. Greater the exposure, brighter is the image, while lesser the exposure, darker is the image. For applying the exposure setting, a colour value of each pixel in the HDR image is multiplied by a constant value that is uniform throughout the HDR frame. Such a constant value is used to control an overall brightness of the HDR image. As an example, when the colour value of each pixel is multiplied by a content value greater than 1, the HDR image may get brighter, whereas when the colour value of each pixel is multiplied by a constant value less than 1, the HDR image may get darker. Additionally, a brightness value (for example, expressed in terms of lumens) of each pixel in the HDR image is mapped to a 0 to 1 range, which represents how saturated a photoreceptor (like a pixel on a camera sensor or a receptor in the human eye) is. A brightness value of 0 means fully black pixel, and a brightness value of 1 means a fully saturated/brightest pixel. Upon adjusting the exposure setting, some pixels in the HDR image may still have brightness values greater than 1, meaning that they are brighter than what a current exposure setting is capable of representing. These pixels are called saturated pixels. The tone-mapping techniques is then applied to retain colour tones and prominent visual details represented by such saturated pixels. In an example, when the tone-mapping technique is not employed, a colour value (10, 1.5, 1.5) of a red colour pixel in the HDR image (in an RGB domain) that's beyond a displayable range, would simply get clipped to a maximum colour value (1, 1, 1) that represents a white pixel in the output image. This would result in a loss of colour information. On the other hand, when the tone-mapping technique is employed (for example, based on a typical tone-mapping curve), colour value of the red colour pixel would get mapped to a colour value (0.99, 0.85, 0.85) of a corresponding pixel in the output image, thereby preserving a red tint but reducing an overall brightness of the red colour pixel. Thus, the tone-mapping technique facilitates in adjusting colour values to match a new backlight brightness range. In this way, 8-bit colour range or 10-bit colour range of the at least one display can be matched with a current condition of the user's eyes.

Throughout the present disclosure, the term “display” refers to an element from which light emanates. The at least one display is driven to display output image(s) in real time or near-real time. Examples of the at least one display include, but are not limited to, a Liquid Crystal Display (LCD), a Light-Emitting Diode (LED)-based display, an Organic LED (OLED)-based display, a micro OLED-based display, an Active Matrix OLED (AMOLED)-based display, and a Liquid Crystal on Silicon (LCoS)-based display. The at least one display could also be implemented as a projector. Displays and projectors are well-known in the art.

Optionally, the at least one processor is configured to extend the upper bound of the given luminosity range by a predefined threshold. In this regard, when the user views a particular region in the output image having a relatively higher brightness, the upper bound of the given luminosity range that was comfortable to the user's eye is (slightly) increased in order to ensure that when the user views said particular region, the pupil of the user's eye should naturally contract or become small in size due to an increased luminosity/brightness. This would prevent the user from being stuck in a dark vision mode when viewing the output image, if a same upper bound would be employed every time irrespective of different brightness levels of different regions in the output image. As an example, a full brightness that can be displayed (mainly, a full white, but also a full red, a full green, or a full blue) at the at least one display may be a slightly more than the given luminosity range. Optionally, the predefined threshold lies in a range of 100 percent to 125 percent of the upper bound of the given luminosity range.

In an embodiment, the at least one display comprises a backlight, wherein the at least one processor is configured to adjust a brightness of the backlight according to the upper bound of the given luminosity range. In this regard, the backlight produces a maximum brightness that can be displayed (for an entirety of the output image) in the given luminosity range. Greater the upper bound of the given luminosity range, greater is the brightness of the backlight, and vice versa. It will be appreciated that the at least one display has other components (for example, a polariser, a liquid crystal layer, and the like) that are controlled by the at least one processor, on a per-pixel basis, to allow how much (namely, what percentage) of said maximum brightness (namely, maximum light intensity) is required for a given pixel, and pass only that much amount of light intensity through the pixel towards the user's eye. Beneficially, in this way, the backlight need not always produce an extremely high brightness, as producing the brightness according to the upper bound is sufficient enough for displaying the output image at the at least one display realistically. The term “backlight” refers to a light-emitting element that is capable of illuminating the at least one display by producing white light. The backlight is well-known in the art.

In another embodiment, wherein the at least one display is implemented as an organic light-emitting-diode (OLED) display, and wherein a maximum brightness level employable for a given pixel of the OLED display is equal to the upper bound of the given luminosity range. In this regard, since no backlight is used for the OLED display, light intensity (namely, brightness) for each pixel of the OLED display is individually produced (namely, emitted) because each pixel in the OLED display is made up of organic components that emit light when an electric current is applied to them. The OLED display is well-known in the art. Since all pixels of the OLED display do not necessarily produce a maximum brightness, thus for those pixels that need to produce the maximum brightness (for example, in a case when said pixels represent an object such as the Sun), the maximum brightness level that can be produced for such pixels is equal to the upper bound of the given luminosity range. In this way, the output image is realistically displayed at the at least one display.

Optionally, the at least one processor is configured to:
process the eye-tracking data to determine a gaze direction of the user's eye;
determine a gaze region of the HDR image, based on the gaze direction; and
adjust at least one of: a lower bound, the upper bound, of the given luminosity range, based on luminosity values of pixels in the gaze region of the HDR image.

Herein, the term “gaze direction” refers to a direction in which the user's eye is gazing. The gaze direction may be represented by a gaze vector. Optionally, when processing the eye-tracking data, the processor is configured to employ at least one of: an image processing algorithm, a feature extraction algorithm, a data processing algorithm. Determining the gaze direction of the user's eye allows the at least one processor to track where the user is looking/gazing. Processing the eye-tracking data to determine the gaze direction is well-known in the art. It will be appreciated that the eye-tracking data is collected repeatedly throughout the given session of using the display apparatus, as gaze of the user's eyes keeps changing whilst he/she uses the display apparatus.

Optionally, the gaze direction is a current gaze direction. Alternatively, optionally, the gaze direction is a predicted gaze direction. It will be appreciated that optionally the predicted gaze direction is predicted, based on a change in user's gaze, wherein the predicted gaze direction lies along a direction of the change in the user's gaze. In such a case, the change in the user's gaze could be determined in terms of a gaze velocity and/or a gaze acceleration of the given eye, using information indicative of previous gaze directions of the given eye and/or the current gaze direction of the given eye. Yet alternatively, optionally, the gaze direction is a default gaze direction, wherein the default gaze direction is straight towards a centre of a field of view of the user. In this regard, it is considered that the user's gaze is, by default, typically directed towards the centre of his/her field of view. In such a case, a central region of a field of view of the user is resolved to a much greater degree of visual detail, as compared to a remaining, peripheral region of the field of view of the user.

Optionally, when determining the gaze region of the HDR image, the at least one processor is configured to map the gaze direction of the user's eye onto the HDR image. The term “gaze region” refers to a region in the HDR image onto which the gaze direction is mapped. The gaze region could, for example, be at a centre of the HDR image, be a top-left region of the HDR image, a bottom-right region of the HDR image, or similar.

Once the gaze region is determined, luminosity values of the pixels in the gaze region are considered for fine-tuning the at least one of: the lower bound, the upper bound, of the given luminosity range. This is because objects lying within the gaze region (i.e., gaze-contingent objects) are focused onto foveae of user's eyes, and are resolved to a much greater detail as compared to remaining object(s) lying outside the gaze region, and therefore brightness levels of pixels representing such gaze-contingent objects may affect the lower bound and/or the upper bound. Thus, the lower bound and/the upper bound could be adjusted accordingly. Once the aforesaid bounds are adjusted, then only the at least one processor employs the at least one of: the tone-mapping technique, an exposure-adjustment technique, in a same manner as discussed earlier.

Optionally, the at least one processor is configured to:
process the eye-tracking data, to detect when the user's eye is squinting; and
when it is detected that the user's eye is squinting, adjust the upper bound of the given luminosity range iteratively.

It will be appreciated that when the process the eye-tracking data to detect when the user's eye is squinting, the at least one processor is configured to extract a plurality of features of the user's eye from the eye-tracking data, the plurality of features comprising a pupil diameter, an eye shape, positions of eye lids, eye landmarks, and the like, and to analyse changes in the plurality of features, for detecting when the user's eye is squinting. This could be performed using at least one image processing algorithm or at least one machine learning model.

Furthermore, the squinting is a natural response to bright light or glare. When the user is squinting, it may indicate that the user is trying to reduce an amount of light entering his/her eyes, possibly due to discomfort from bright or glaring stimuli. Therefore, the upper bound is decreased when it is detected that the user's eye is squinting. Optionally, by iteratively adjusting the upper bound of the given luminosity range when squinting is detected, a maximum luminosity value (corresponding to a maximum brightness level) of a given pixel is adjusted is dynamically adapt to user's visual comfort. This ensures that visual content represented in the output image remains visible and easy to view even under challenging conditions such as very bright light. This may enhance the user's viewing experience and reduces visual strain.

The present disclosure also relates to the method as described above. Various embodiments and variants disclosed above, with respect to the aforementioned display apparatus, apply mutatis mutandis to the method.

Optionally, the method further comprises extending the upper bound of the given luminosity range by a predefined threshold.

In an embodiment, the at least one display comprises a backlight, wherein the method further comprises adjusting a brightness of the backlight according to the upper bound of the given luminosity range.

In another embodiment, in the method, the at least one display is implemented as an organic light-emitting-diode (OLED) display, and wherein a maximum brightness level employable for a given pixel of the OLED display is equal to the upper bound of the given luminosity range.

Optionally, the method further comprises adjusting an exposure setting of the tone-mapping technique based on the given luminosity range.

Optionally, the method further comprises:
processing the eye-tracking data to determine a gaze direction of the user's eye;
determining a gaze region of the HDR image, based on the gaze direction; and
adjusting at least one of: a lower bound, the upper bound, of the given luminosity range, based on luminosity values of pixels in the gaze region of the HDR image.

Optionally, the method further comprises:
processing the eye-tracking data, to detect when the user's eye is squinting; and
when it is detected that the user's eye is squinting, adjusting the upper bound of the given luminosity range iteratively.

### DETAILED DESCRIPTION OF THE DRAWINGS

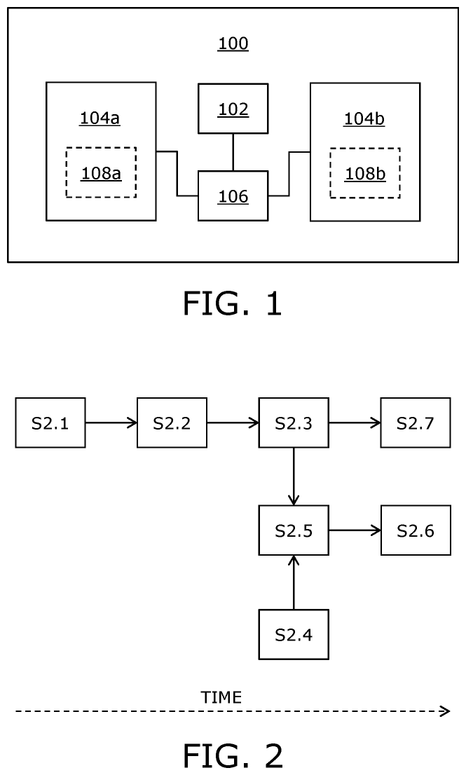

Referring to FIG. 1, illustrated is a block diagram of an architecture of an eye-adaptive display apparatus 100, in accordance with an embodiment of the present disclosure. The display apparatus 100 comprises eye-tracking means 102, at least one display per eye (depicted as a display 104a for a right eye, and a display 104b for a left eye), and at least one processor (depicted as a processor 106). Optionally, the display 104a comprises a backlight 108a, and the display 104b comprises a backlight 108b. The processor 106 is communicably coupled with the eye-tracking means 102 and to the displays 104a-b. The processor 106 is configured to perform various operations, as described earlier with respect to the aforementioned first aspect.

It may be understood by a person skilled in the art that the FIG. 1 includes a simplified architecture of the eye-adaptive display apparatus 100 for sake of clarity, which should not unduly limit the scope of the claims herein. It is to be understood that the specific implementation of the eye-adaptive display apparatus 100 is provided as an example and is not to be construed as limiting it to specific numbers or types of eye-tracking means, displays, backlights, and processors. The person skilled in the art will recognize many variations, alternatives, and modifications of embodiments of the present disclosure.

Referring to FIG. 2, illustrated is an exemplary sequence diagram of a data flow in an eye-adaptive display apparatus, in accordance with an embodiment of the present disclosure. At step S2.1, at least one processor controls eye-tracking means to collect eye-tracking data. At step S2.2, the at least one processor processes the eye-tracking data to detect a current pupil size of a user's eye. At step S2.3, the at least one processor determines a given luminosity range corresponding to the current pupil size. At step S2.4, the at least one processor obtains a high dynamic range (HDR) image, for example, from a data repository or an HDR content framebuffer. At step S2.5, the at least one processor employs at least one of: a tone-mapping technique, an exposure-adjustment technique, to map luminosity values of pixels in the HDR image to luminosity values of corresponding pixels in an output image, wherein the luminosity values of the pixels in the output image lie in the given luminosity range. At step S2.6, the at least one processor displays the output image via at least one display. Simultaneously, at step S2.7, the at least one processor adjusts a brightness of a backlight of the at least one display according to an upper bound of the given luminosity range.

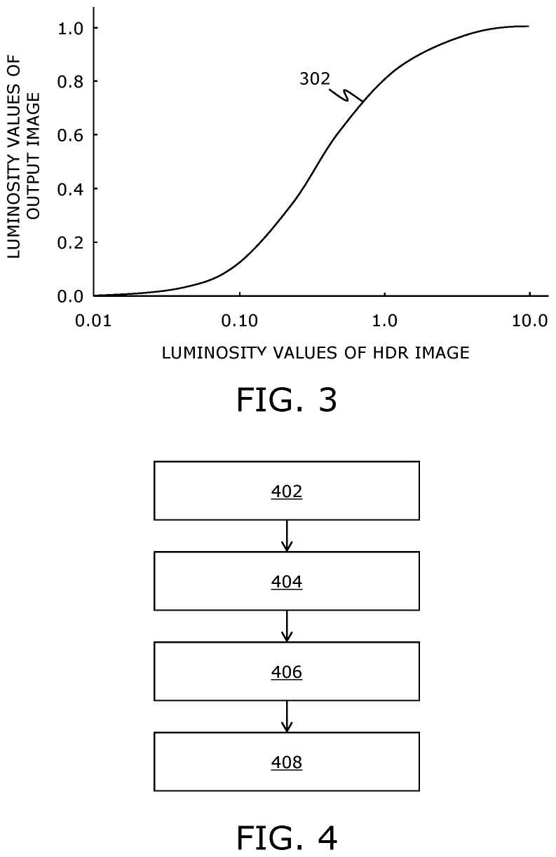

Referring to FIG. 3, illustrated is an exemplary tone mapping curve 302 representing a non-linear mapping of luminosity values of pixels in a high dynamic range (HDR) image to luminosity values of corresponding pixels in an output image, in accordance with an embodiment of the present disclosure. Herein, the HDR image is considered to be a 10-bit image, whereas the output image is considered to be an 8-bit image. The tone mapping curve 302 has an “S” shape. The non-linear mapping is performed in a manner that the luminosity values of the pixels in the HDR image are compressed to fit into a narrower luminosity range for the output image, while preserving visual details of both shadows (namely, darker areas) and highlights (namely, brighter areas) in the output image. In other words, the tone mapping curve 302 starts with a gentle slope, indicating that dark areas are preserved and not compressed significantly in the output image. A middle portion of the tone mapping curve 302 forms an S shape, indicating a gradually compression of luminosity values of pixels in mid-tone regions, and retaining details and contrast in the output image. The tone mapping curve 302 ends with another gentle slope, indicating that brightest areas are also preserved and not overexposed in the output image. A purpose of utilising the tone mapping curve 302 for the aforesaid mapping is to create a visually pleasing and realistic representation of HDR images on display devices with a limited dynamic range. Such a tone mapping curve is well-known in the art.

FIGS. 2 and 3 are merely examples, which should not unduly limit the scope of the claims herein. The person skilled in the art will recognize many variations, alternatives, and modifications of embodiments of the present disclosure.

Referring to FIG. 4, illustrated are steps of a method implemented by an eye-adaptive display apparatus, in accordance with an embodiment of the present disclosure. At step 402, eye-tracking data, collected by eye-tracking means, is processed to detect a current pupil size of a user's eye. At step 404, a given luminosity range corresponding to the current pupil size is determined. At step 406, at least one of: a tone-mapping technique, an exposure-adjustment technique, is employed to map luminosity values of pixels in a high dynamic range (HDR) image to luminosity values of corresponding pixels in an output image, wherein the luminosity values of the pixels in the output image lie in the given luminosity range. At step 408, the output image is displayed via at least one display.

The aforementioned steps are only illustrative and other alternatives can also be provided where one or more steps are added, one or more steps are removed, or one or more steps are provided in a different sequence without departing from the scope of the claims.

1. A display apparatus comprising:
eye-tracking means;
at least one display per eye; and
at least one processor configured to:
process eye-tracking data, collected by the eye-tracking means, to detect a current pupil size of a user's eye;
determine a given luminosity range corresponding to the current pupil size;
employ at least one of: a tone-mapping technique, an exposure-adjustment technique, to map luminosity values of pixels in a high dynamic range (HDR) image to luminosity values of corresponding pixels in an output image, wherein the luminosity values of the pixels in the output image lie in the given luminosity range; and
display the output image via the at least one display.

2. The display apparatus of claim 1, wherein the at least one processor is configured to extend the upper bound of the given luminosity range by a predefined threshold.

3. The display apparatus of claim 1, wherein the at least one display comprises a backlight, wherein the at least one processor is configured to adjust a brightness of the backlight according to the upper bound of the given luminosity range.

4. The display apparatus of claim 1, wherein the at least one display is implemented as an organic light-emitting-diode (OLED) display, and wherein a maximum brightness level employable for a given pixel of the OLED display is equal to the upper bound of the given luminosity range.

5. The display apparatus of claim 1, wherein the at least one processor is configured to adjust an exposure setting of the tone-mapping technique based on the given luminosity range.

6. The display apparatus of claim 1, wherein the at least one processor is configured to:
process the eye-tracking data to determine a gaze direction of the user's eye;
determine a gaze region of the HDR image, based on the gaze direction; and
adjust at least one of: a lower bound, the upper bound, of the given luminosity range, based on luminosity values of pixels in the gaze region of the HDR image.

7. The display apparatus of claim 1, wherein the at least one processor is configured to:
process the eye-tracking data, to detect when the user's eye is squinting; and
when it is detected that the user's eye is squinting, adjust the upper bound of the given luminosity range iteratively.

8. The display apparatus of claim 1, wherein a luminosity value of a given pixel in the HDR image that is higher than an upper bound of the given luminosity range is mapped to the upper bound.

9. A method comprising:
processing eye-tracking data, collected by eye-tracking means, to detect a current pupil size of a user's eye;
determining a given luminosity range corresponding to the current pupil size;
employing at least one of: a tone-mapping technique, an exposure-adjustment technique to map luminosity values of pixels in a high dynamic range (HDR) image to luminosity values of corresponding pixels in an output image, wherein the luminosity values of the pixels in the output image lie in the given luminosity range, and wherein a luminosity value of a given pixel in the HDR image that is higher than an upper bound of the given luminosity range is mapped to the upper bound; and
displaying the output image via at least one display.

10. The method of claim 9, further comprising extending the upper bound of the given luminosity range by a predefined threshold.

11. The method of claim 9, wherein the at least one display comprises a backlight, wherein the method further comprises adjusting a brightness of the backlight according to the upper bound of the given luminosity range.

12. The method of claim 9, wherein the at least one display is implemented as an organic light-emitting-diode (OLED) display, and wherein a maximum brightness level employable for a given pixel of the OLED display is equal to the upper bound of the given luminosity range.

13. The method of claim 9, further comprising adjusting an exposure setting of the tone-mapping technique based on the given luminosity range.

14. The method of claim 9, further comprising:
processing the eye-tracking data to determine a gaze direction of the user's eye;
determining a gaze region of the HDR image, based on the gaze direction; and
adjusting at least one of: a lower bound, the upper bound, of the given luminosity range, based on luminosity values of pixels in the gaze region of the HDR image.

15. The method of claim 9, further comprising:
processing the eye-tracking data, to detect when the user's eye is squinting; and
when it is detected that the user's eye is squinting, adjusting the upper bound of the given luminosity range iteratively.
